(19) United States
(12) Patent Application Publication
(10) Pub. No.: US 2026/0302433 A1
(43) Pub. Date: Oct. 1, 2026

(54) METAL-AIR BATTERY, METAL-AIR-BATTERY SYSTEM, AND OPERATION METHOD OF THE METAL-AIR BATTERY SYSTEM

(71) Applicant: Samsung Electronics Co., Ltd., Suwon-si (KR)

(72) Inventors: Jaeho Shin, Suwon-si (KR); Mokwon Kim, Suwon-si (KR); Taeyoung Kim, Suwon-si (KR); Jungock Park, Suwon-si (KR); Heungchan Lee, Suwon-si (KR)

(21) Appl. No.: 19/441,181

(22) Filed: Jan. 6, 2026

(30) Foreign Application Priority Data
Feb. 3, 2025 (KR) 10-2025-0013288

(51) Int. Cl. H01M 12/06; H01M 10/48; H01M 12/02

(52) U.S. Cl. CPC H01M 12/06; H01M 10/48; H01M 12/02

(57) ABSTRACT

A metal-air battery includes a unit battery cell and a weight sensor. The unit battery cell, which includes anolyte, a supporter, an anode being suspended from the supporter, and a cathode, is configured to generate electricity by using an oxygen reduction reaction in the cathode and an oxidation reaction of the anode. The weight sensor is configured to determine a weight of the anode of the unit battery cell. A metal-air battery system includes a metal-air battery and a controller configured to generate, based on a result of sensing by the weight sensor, a maintenance signal for the anode.

### CROSS-REFERENCE TO RELATED APPLICATION

This application claims priority to and the benefit of Korean Patent Application No. 10-2025-0013288, filed on Feb. 3, 2025, in the Korean Intellectual Property Office, and all the benefits accruing therefrom under 35 U.S.C. § 119, the content of which in its entirety is herein incorporated by reference.

### BACKGROUND

### 1. Field

The disclosure relates to a metal-air battery, a metal-air battery system, and an operation method of the metal-air battery system.

### 2. Description of the Related Art

Lithium-ion-batteries (LIBs) or next-generation secondary batteries have been studied in the context of carbon neutrality and eco-friendly energy. However, the cost and stability of these secondary batteries may limit use thereof in large-scale energy storage systems (ESS) or power generation. For example, for power generation, the unit costs of batteries are directly related to rates of profit, cost is a highly important issue, and from this point of view, metal-air batteries, which have low unit costs and use safe materials, have drawn attention.

### SUMMARY

Provided is a metal-air battery configured to sense a consumption of an anode, a metal-air battery system, and an operation method of the metal-air battery system.

Provided is a metal-air battery configured to sense degradation in performance due to difference between consumptions, for example, by measuring consumption, of anodes in a plurality of unit battery cells, a metal-air battery system, and an operation method of the metal-air battery system.

Provided is a metal-air battery having stable power generation performance, a metal-air battery system, and an operation of the metal-air battery system.

Additional aspects will be set forth in part in the description which follows and, in part, will be apparent from the description, or may be learned by practice of an embodiment of the disclosure.

According to an embodiment of the disclosure, a metal-air battery includes a unit battery cell including an anolyte, a supporter, an anode being suspended from the supporter, and a cathode, the unit battery cell configured to generate electricity by using oxygen reduction reaction in the cathode and oxidation reaction of the anode; and a weight sensor configured to determine a weight of the anode of the unit battery cell.

In an embodiment, the weight sensor may include a load cell, and the load cell may be between the anode and the supporter.

In an embodiment, the metal-air battery may further include a spring, the spring may be between the anode and the supporter, and the weight sensor may be configured to measure a length of the spring from an image of the spring.

In an embodiment, the metal-air battery may further include a spring, the anode may include a reflective pattern with varying reflectance in a direction of gravity, the spring may be between the anode and the supporter, and the weight sensor may be configured to measure an amount of light reflected from the reflective pattern.

In an embodiment, the metal-air battery may include a plurality of the unit battery cells. The plurality of unit battery cells may include at least one first unit battery cell positioned at a center portion in an alignment direction and second unit battery cells positioned at both end portions in the alignment direction. The weight sensor may be configured to determine a weight of an anode of at least one first unit battery cell of the at least one first unit battery cell and a weight of an anode of at least one second unit battery cell of the second unit battery cells.

In an embodiment, the metal-air battery may include a plurality of battery cell stacks each including a plurality of the unit battery cells, and the weight sensor may be configured to determine a weight of at least one anode of each of the plurality of battery cell stacks.

In an embodiment, the anode may include zinc, iron, aluminum, or an alloy including at least two of zinc, iron, and aluminum.

According to an embodiment of the disclosure, a metal-air battery system includes a metal-air battery including a unit battery cell and a weight sensor, wherein the unit battery unit cell includes an anolyte, a supporter, an anode being suspended from the supporter, and a cathode and is configured to generate electricity by using an oxygen reduction reaction in the cathode and an oxidation reaction of the anode, and the weight sensor is configured to determine a weight of the anode of the unit battery cell; and a controller configured to, based on a result of sensing by the weight sensor, generate a maintenance signal for the anode.

In an embodiment, the controller may be configured to output the maintenance signal through an output interface, transmit the maintenance signal to outside of the metal-air battery system, or a combination thereof.

In an embodiment, the metal-air battery may include a plurality of the unit battery cells. The plurality of unit battery cells may include at least one first unit battery cell positioned at a center portion in an alignment direction and second unit battery cells positioned at both end portions in the alignment direction. The weight sensor may be configured to determine a weight of an anode of at least one first unit battery cell of the at least one first unit battery cell and at least one second unit battery cell of the second unit battery cells. The controller is configured to, when a difference between the weight of the anode of the at least one first unit battery cell that has been measured and the weight of the anode of the at least one second unit battery cell of the second unit battery cells that has been measured is greater than or equal to a reference value, generate a maintenance signal for a unit battery cell having a lower weight of the anode.

In an embodiment, the controller may be configured to generate the maintenance signal based on a difference between an average value of the weights of the anodes of the first unit battery cells that have been measured and an average value of the weights of the anodes of the second unit battery cells that have been measured.

The controller may be configured to generate the maintenance signal based on a maximum value of differences between the weights of the anodes of the first unit battery cells that have been measured and the weights of the anodes of the second unit battery cells that have been measured.

In an embodiment, the anode may include zinc, iron, aluminum, or alloys including at least two of zinc, iron, and aluminum.

In an embodiment, the metal-air battery system may include a plurality of battery cell stacks each including a plurality of the unit battery cells, and the weight sensor may be configured to determine a weight of at least one anode of each of the plurality of battery cell stacks.

According to an embodiment of the disclosure, an operation method of a metal-air battery system includes preparing a metal-air battery and a weight sensor, wherein the metal-air battery includes a unit battery cell including an anolyte, a supporter, an anode being suspended from the supporter, and a cathode, the unit battery cell configured to generate electricity by using an oxygen reduction reaction in the cathode and an oxidation reaction of the anode, and the weight sensor is configured to determine a weight of the anode of the unit battery cell, determining a weight of the anode of the unit battery cell using the weight sensor, and generating a maintenance signal for the anode, based on a result of sensing by the weight sensor.

In an embodiment, the operation method may further include displaying the maintenance signal through an interface, transmitting the maintenance signal to outside of the metal-air battery system, or a combination thereof.

In an embodiment, in the generating of the maintenance signal, the maintenance signal may be generated when the weight of the anode that has been measured is less than or equal to a reference value.

In an embodiment, the metal-air battery may include a plurality of the unit battery cells. The plurality of unit battery cells may include at least one first unit battery cell positioned at a center portion in an alignment direction and second unit battery cells positioned at both end portions in the alignment direction. The sensing of the weight may include sensing weights of anodes of at least one first unit battery cell of the at least one first unit battery cell and at least one second unit battery cell of the second unit battery cells. The generating of the maintenance signal may include generating a maintenance signal for a unit battery cell having a lowest weight of the anode, based on one of: a difference between weights of anodes of the first unit battery cells that have been measured and weights of anodes of the second unit battery cells that have been measured; a difference between an average value of the weights of the anodes of the first unit battery cells that have been measured and an average value of the weights of the anodes of the second unit battery cells that have been measured; and a maximum value among the differences between the weights of the anodes of the first unit battery cells that have been measured and the weights of the anodes of the second unit battery cells.

In an embodiment, the operation method may further include adjusting an amount of supply of the anolyte, an amount of air supply to the cathode, or a combination thereof, based on a result of sensing by the weight sensor.

In an embodiment, the metal-air battery may include a plurality of battery cell stacks each including a plurality of unit battery cells, and sensing of the weight may include determining a weight of at least one anode of each of the plurality of battery cell stacks.

In an embodiment, an operation method of a metal-air battery system including a plurality of unit battery cells, each of the unit battery cells including an anolyte, an anode, and a cathode and being configured to generate electricity by using an oxygen reduction reaction in the cathode and an oxidation reaction of the anode, the operation method including determining a weight of the anodes of each of the unit battery cells using a weight sensor; and adjusting an amount of supply of the anolyte, adjusting an amount of air supply to at least one cathode, replacing at least one anode, or a combination thereof, when a consumption of the anodes is not uniform.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a configuration diagram schematically illustrating a metal-air battery system according to an embodiment;

FIG. 2 is a diagram schematically illustrating an embodiment of a unit battery cell illustrated in FIG. 1;

FIG. 3 is a configuration diagram schematically illustrating an embodiment of a weight sensor;

FIG. 4 illustrates an embodiment of a load cell;

FIG. 5 is a configuration diagram schematically illustrating an embodiment of a weight sensor;

FIG. 6 is a configuration diagram schematically illustrating an embodiment of a weight sensor;

FIG. 7 illustrates an example of an arrangement of a weight sensor; and

FIG. 8 is a flowchart of an embodiment of an operation method of a metal-air battery system.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, an embodiment of a metal-air battery, a metal-air battery system, and an operation method of the metal-air battery system, will be described in detail with reference to the accompanying drawings. In the following drawings, same reference numerals indicate same components, and sizes of the components such as widths and thickness of layers in the drawings may be exaggerated for clarity and convenience of explanation. Terms such as “first,” and “second” may be used for describing various components, but the components will not be limited by the terms. The terms are only used to distinguish one component from other components.

Unless explicitly intended otherwise, singular form expressions also encompass plural form expressions. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. Thus, reference to “an” element in a claim followed by reference to “the” element is inclusive of one element and a plurality of the elements. In addition, when a portion “includes” a component, unless particularly described otherwise, this indicates that the portion may further include other components, rather than that the other components are excluded. Furthermore, when it is described that a certain material layer is on a substrate or another layer, the material layer may exist in a manner of being in direct contact with the substrate or the other layer, and yet another layer may exist therebetween. In addition, in the following embodiments, materials included in layers are only examples, and therefore, other materials may be used.

Furthermore, relative terms, such as “lower” and “upper” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Unless otherwise defined, all terms (including technical and scientific terms) used herein have the same meaning as commonly understood by one of ordinary skill in the art to which this disclosure belongs. It will be further understood that terms, such as those defined in commonly used, e.g., non-technical, dictionaries, should be interpreted as having a meaning that is consistent with their meaning in the context of the relevant art and the present disclosure, and will not be interpreted in an idealized or overly formal sense unless expressly so defined herein.

Furthermore, terms such as “...unit,” “module” and the like in the specification indicate a unit configured to process at least one function or operation, and may be implemented as hardware or software, or a combination of hardware and software.

Certain implementations described in the embodiments are only examples, and are not intended to the technical scope by any means. For the brevity of the specification, descriptions about other functional aspects of electronic configurations, control systems, software, and the systems in the related art may be omitted. In addition, linear connections or connectors between the components in the drawings illustrate examples of functional connections and/or physical or circuit connections, and may be presented in actual devices in the forms of various types of replaceable or additional functional connections, physical connections, or circuit connections.

Use of the term “the” and other similar indicatory terms may be applicable to singular form expressions and plural form expressions.

Unless explicitly mentioned, operations included in a method may be performed in appropriate orders. In addition, use of any example terms (for example, and the like) are only to describe the technical scope in detail, and the scope of the disclosure is not limited by the terms unless defined by the following claims.

Hereinafter, a metal-air battery according to an embodiment will be described in detail with reference to the accompanying drawings. Throughout the detailed description, same reference numerals indicate same components.

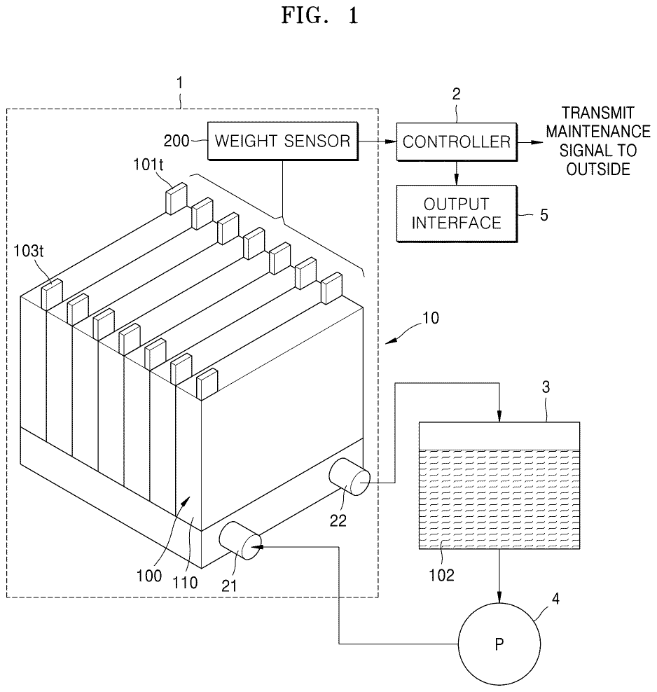

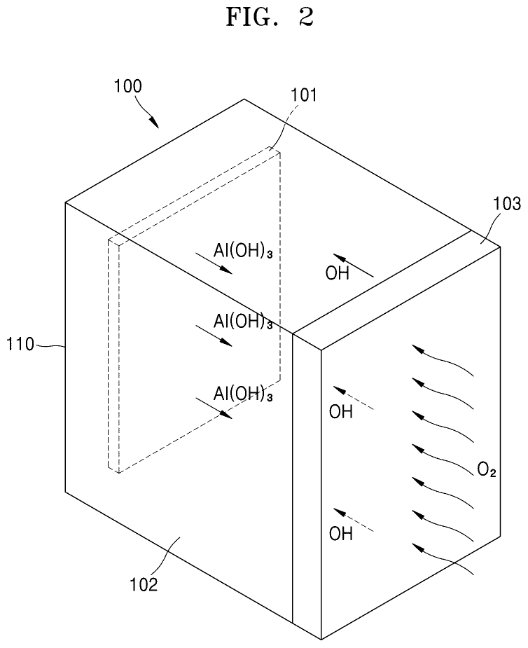

FIG. 1 is a configuration diagram schematically illustrating a metal-air battery system according to an embodiment. FIG. 2 is a schematic diagram illustrating an embodiment of a unit battery cell 100 illustrated in FIG. 1.

Referring to FIGS. 1 and 2, the metal-air battery system according to an example may include a metal-air battery 1, as a primary battery, and a controller 2. The metal-air battery system may further include a reservoir 3, in which an anolyte 102 is stored, and a pump 4. The metal-air battery 1 may include one or more unit battery cells 100 and a weight sensor 200. The weight sensor 200 may be configured to sense, e.g., determine, a weight of an anode 101 of the one or more unit battery cells 100. In an embodiment, the metal-air battery 1 includes a plurality of unit battery cells 100. The plurality of unit battery cells 100 may form one or more battery cell stack(s) 10. For example, as illustrated in FIG. 1, the unit battery cells 100 may be aligned in a direction, e.g., a thickness direction of the unit battery cell 100, to form one battery cell stack 10. Although not illustrated in the drawings, the metal-air battery 1 may also include a plurality of battery cell stacks 10. For example, the plurality of battery cells tacks 10 may be connected in series or in parallel. For example, the plurality of battery cell stacks 10 connected in series may form a battery cell stack group, and the plurality of battery cell stacks may be connected in parallel.

The unit battery cell 100 may include the anode 101, an anolyte 102, and a cathode 103. The anode 101, the anolyte 102, and the cathode 103 may be accommodated in a battery case 110.

In an embodiment, although not illustrated in the drawings, the unit battery cell 100 may further include an ion exchange membrane. The anode 101 may be in contact with the anolyte 102, and the ion exchange membrane may be between the cathode 103 and the anolyte 102. Although not illustrated in the drawings, catholyte may be between the ion exchange membrane and the cathode 103, and the anolyte 102 may be referred to as anolyte.

The anolyte 102 may include aqueous electrolyte that may provide hydroxyl (OH⁻) group ions through reaction with oxygen provided from the cathode 103. For example, the anolyte 102 may include strong base-aqueous solution. For example, the anolyte 102 may include KOH, NaOH, or a combination thereof. The anolyte 102 may further include organic/inorganic additives for preventing corrosion of the anode 101.

The anolyte 102 may be, for example, provided from the reservoir 3 to each of the unit battery cells 100. For example, the anolyte 102 drawn out of the reservoir 3 may be provided to the battery cell stack 10 through an inlet 21. The anolyte 102 may diverge into a plurality of flow paths and may be provided into the battery case 110 of each of the plurality of unit battery cells 100. The anolyte 102 discharged from the battery case 110 of each of the plurality of unit battery cells 100 may be discharged to the reservoir 3 through an outlet 22. A pump 4 may circulate the anolyte 102 between the one or the plurality of unit battery cell(s) 100 and the reservoir 3.

The anode 101 may be in contact with the anolyte 102. For example, the anolyte 102 may be accommodated in the battery case 110, and the anode 101 may be submerged in the anolyte 102. The anode 101 may include materials that may discharge metal ions. Such materials may include, for example, zinc (Zn), iron (Fe), aluminum (Al), or an alloy including at least two of Zn, Fe, and Al. The anode 101 may have, e.g., be in, the form of a thin plate as illustrated in FIG. 2, to secure a contact area with the anolyte 102, but is not limited thereto.

For example, the anode 101 may include Al, and the metal-air battery 1 may be referred to as an aluminum air battery (AAB). Although not illustrated in the drawings, an anode current collector may be arranged in contact with the anode 101. The anode current collector may include a conductor, for example, stainless steel. An anode terminal 101t may be connected to the anode 101, directly or with the anode current collector therebetween.

An oxygen reduction reaction (ORR) may occur in the cathode 103. Oxygen (O₂) outside (e.g., outside of the unit battery cell 100), for example, in the air, may be provided to the cathode 103, and a hydroxyl group (OH⁻) may be generated by a reduction reaction of vapor (H₂O) due to oxygen (O₂), e.g., by a reduction reaction of oxygen (O₂) present in vapor (H₂O). The hydroxyl group (OH⁻) may be provided to the anode 101, and may be combined to, e.g., with, a metal ion provided by the anode 101. The cathode 103 may provide a path through which electrons for an ORR may move.

Although not illustrated in FIG. 2, a gas diffusion layer to absorb oxygen in the atmosphere and provide the oxygen to the cathode 103 may be provided. The gas diffusion layer may have a porous structure such that oxygen may be smoothly diffused. For example, the gas diffusion layer may include carbon paper in which carbon fibers are used, carbon cloth, carbon felt, or a foam metal having a sponge phase, a metal fiber mat, and the like. The cathode 103 may have a porous structure or a structure similar thereto to also function as the gas diffusion layer, and the gas diffusion layer may be omitted.

Although not illustrated in the drawings, a cathode current collector may be arranged in contact with the cathode 103. The cathode current collector may include a conductor, for example, stainless steel. The cathode current collector may be in contact with the gas diffusion layer, and the cathode current collector may have a mesh structure through which air may penetrate or permeate. A cathode terminal 103t may be connected to the cathode 103, directly or via the cathode current collector therebetween.

For example, when Al is used as the anode 101, reactions occurring when the metal-air battery is discharged are as follows:
Reaction in the cathode: 3O₂+6H₂O+12e⁻→12OH⁻ E₀=+0.4 V
Reaction in the anode: 4Al+12OH⁻→4Al(OH)₃+12e⁻ E0=−2.31 V
Total reactions: 4Al+3O₂+6H₂O→4Al(OH)₃ E₀=+2.71 V

Water (H₂O) and oxygen (O₂) provided from air together may combine to, e.g., with, an electron (e⁻) on a surface of the cathode 103 to form a hydroxyl group (OH⁻). As Al in the anode 101 reacts with the hydroxyl group (OH—), aluminum hydroxide (Al(OH)₃) and the electron (e−) may be generated as reaction products. The electron (e⁻) may be provided to the cathode 103 through the anode terminal 101t, unillustrated wires, and the cathode terminal 103t. Power may be generated through the disclosed process. As the process is in progress, Al in the anode 101 may be consumed, and the weight of the anode 101 may decrease. The metal-air battery 1 may generate electricity until the anode 101 is used up, e.g., consumed, to at least a certain amount, for example, the entire amount, e.g., an entirety of the anode 101 is consumed, and the metal-air battery 1 according to the disclosure may be a primary battery configured to irreversibly consume the anode 101. When the anode 101 is consumed, e.g., entirely used up, an operation of the unit battery cell 100 ends. The unit battery cell 100 may be operated again by replacing the consumed anode 101 with a new anode 101.

The unit battery cells 100 may be connected in series, and a voltage generated by all unit battery cells 100 may be obtained by multiplying the number of unit battery cells 100 to a voltage generated by each of the unit battery cells 100. The plurality of unit battery cells 100 included in a single battery cell stack 10 may be connected in series, and a voltage generated by the single battery cell stack 10 may be obtained by multiplying the number of plurality of unit battery cells 100 included in the single battery cell stack 10 to the voltage generated by each of the unit battery cells 100.

When the battery cell stack 10 operates, various factors may result in non-uniformity in a consumption of the anodes 101 in the plurality of unit battery cells 100 included in the battery cell stack 10. Factors causing a difference in consumptions of the anodes 101 may include, for example, a temperature difference between the unit battery cells 100, a difference in a flow rate of the anolyte 102 provided to the unit battery cells 100, a difference in the quality of the cathodes 103 of the unit battery cells 103, a difference in an amount of air supply to the cathodes 103 of the unit battery cells 100. When a difference occurs between the consumptions of the anodes 101 of the plurality of unit battery cells 100, the performance of the battery cell stack 10 may be degraded.

For example, five unit battery cells 100 may form one battery cell stack 10 and the battery cell stack 10 may generate a voltage of 10 volts (V) as each of the five unit battery cells 100 generates a voltage of 2 V. When a consumption of the anode 101 in any one of (the unit battery cell that has been consumed) among the five unit battery cells 100 is greater than consumptions of the anodes 101 in the other unit battery cells 100, the unit battery cell that has been consumed may generate a voltage lower than 2 V. In a case of the unit battery cell that has been consumed, an area of the anode 101 in contact with the anolyte 102 may decrease, a current density at the anode 101 may increase, and a voltage may drop. Consumption of the anode 101 may increase as a depth-of-discharge (DOD) increases (i.e., as a remaining lifetime of the unit battery cell 10 decreases), the consumption of the anode 101 of the unit battery cell that has been consumed may increase more rapidly, and the performance of the battery cell stack 10 may fall behind, e.g., be less than, design specifications. Technical solutions for appropriately counteracting the consumption of the anode 101 are desired, for example, sensing DOD and replacing the anode 101.

DOD may be sensed based on the consumption of the anode 101. The anode 101 may be irreversibly consumed, a weight of the anode 101 may decrease as DOD increases, and DOD may be sensed by sensing, e.g., determining, the weight of the anode 101. To sense the consumption of the anode 101, methods such as sensing, e.g., determining, a weight of the entire portion of the unit battery cell 100, sensing, e.g., determining, a weight including weights of the anode 101 and the anolyte 102, may be considered. However, as a portion occupied by the weight of the anode 101 may be smaller than a sensed weight, it may be difficult to precisely measure the weight of the anode through the disclosed methods. For example, as the anolyte 102 is circulated between the plurality of unit battery cells 100 and the reservoir 3, there may be non-uniformity in the weight of the anolyte 102 itself accommodated in the unit battery cell 100. For example, flow of the anolyte 102 may have influence on sensing of the weight of the unit battery cell 100 including the anolyte 102. In consideration thereof, the metal-air battery 1 according to an embodiment includes the weight sensor 200 configured to sense, e.g., determine, the weight of the anode 101 itself.

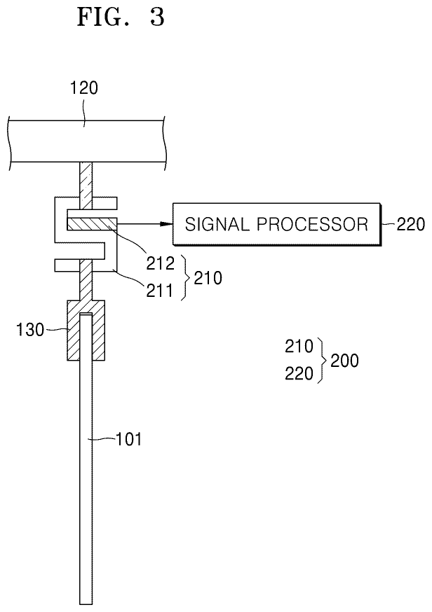

FIG. 3 is a configuration diagram schematically illustrating an embodiment of the weight sensor 200. Referring to FIG. 3, the weight sensor 200 may include a load cell 210. For example, the anode 101 may be installed in a state of being suspended from the supporter 120 with the load cell 210 therebetween. The anode 101 may be installed such that the weight of the anode 101 is applied to the load cell 210. The supporter 120 may include, for example, a portion of the battery case 110, or may include a component separate from the battery case 110. For example, an electrode holder 130 may be installed on an upper end portion of the anode 101. The electrode holder 130 may be connected to a lower end of the load cell 210. An upper end portion of the load cell 210 may be connected to the supporter 120.

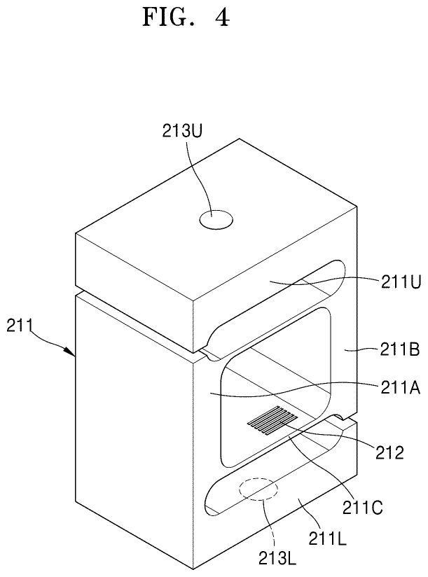

FIG. 4 illustrates an embodiment of the load cell 210. Referring to FIG. 4, the load cell 210 may include a holder 211 and a strain gauge 212. The strain gauge 212 may be configured to sense deformation of the holder 211. An electric resistance value of the strain gauge 212 changes in proportion to an amount of the deformation of the holder 211. The holder 211 may include, for example, a lower arm 211L, a center arm 211C, and an upper arm 211U. An, e.g., a first, end portion of the lower arm 211L and an, e.g., a first, end portion of the center arm 211C may be connected to each other by a first sidewall 211A. The lower arm 211L and the center arm 211C may have a shape like the letter “C” in which a portion opposite to the first sidewall 211A is open. Another, e.g., a second, end portion of the center arm 211C and another, e.g., a second, end portion of the upper arm 211U may be connected to each other by a second sidewall 211B. The center arm 211C and the upper arm 211U may have a shape like the letter “C” in which a portion opposite to the second sidewall 211B is open. The first sidewall 211A and the second sidewall 211B may face each other, and the load cell 210 may generally have a shape like the letter “Z”. A connection hole 213U for connection to the supporter 120 may be provided in the upper arm 211U. A connection hole 213L for connection to the anode 101, i.e., the electrode holder 130, may be provided to the lower arm 211L. The strain gauge 212 may be arranged in the center arm 211C. An electric resistance value of the strain gauge 212 may change in proportion to an amount of deformation of the center arm 211C.

When the anode 101 is installed as illustrated in FIG. 3, stress, which reflects the weight of the anode 101, is applied to the holder 211. The center arm 211C of the holder 211 may be deformed due to, for example, the weight of the anode 101, and the strain gauge 212 arranged in the center arm 211C also may be deformed. The electric resistance value of the strain gauge 212 may change according to the amount of deformation of the strain gauge 212, and the weight of the anode 101 may be sensed by sensing change in the electric resistance value of the strain gauge 212. For example, a signal processor 220 may include a sensing circuit including the strain gauge 212. The signal processor 220 may be configured to convert the electric resistance value of the strain gauge 212 to a voltage value and output the voltage value, and the weight of the anode 101 may be sensed based on an output signal of the signal processor 220. The signal processor 220 may also be provided in the controller 2.

The structure of the load cell 210 illustrated in FIG. 4 is only an example, and the structure of the load cell 210 is not limited thereto. The load cell 210 may have various shapes and structures, including a holder 211 in various forms including a deformation unit (e.g., a center arm 211C) deformed according to the weight of the anode 101 and the strain gauge 212 installed on the deformation unit.

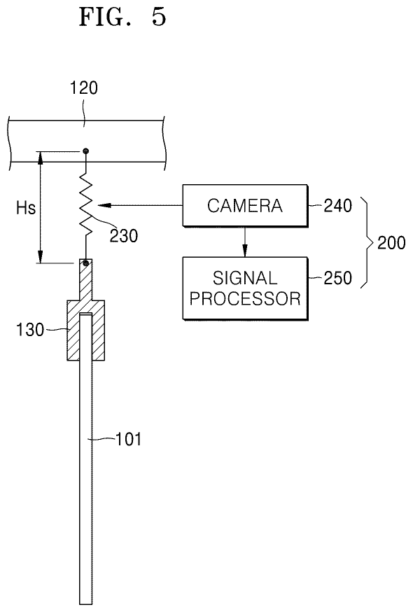

FIG. 5 is a configuration diagram schematically illustrating an embodiment of the weight sensor 200. Referring to FIG. 5, the anode 101 may be installed in a state of being suspended from the supporter 120 with a spring 230 therebetween. The anode 101 may be installed such that the weight of the anode 101 is applied to the spring 230. The weight sensor 200 may be configured to obtain an image of the spring 230 and sense a length of the spring 230 from the obtained image. The supporter 120 may include, for example, a portion of the battery case 110, or may include a component separate from the battery case 110. For example, an electrode holder 130 may be installed on the upper end portion of the anode 101. The spring 230 may include, for example, a tensile coil spring, but is not limited thereto. An, e.g., a first, end portion of the spring 230 may be connected to the electrode holder 130, and another, e.g., a second, end portion of the spring 230 may be connected to the supporter 120.

When the anode 101 is installed as illustrated in FIG. 5, the length Hs of the spring 230 is proportional to the weight of the anode 101. For example, as the anode 101 is consumed, the length Hs of the spring 230 gradually decreases. A camera 240 may be configured to capture the image of the spring 230. The captured image signal is delivered to an image processor 250. The image processor 250 may be configured to sense, e.g., measure, the length Hs of the spring 230 from the image signal. The image processor 250 may be configured to output a signal (e.g., a digital signal) corresponding to the length Hs of the spring 230 and the weight of the anode 101 may be sensed based on the output signal of the image processor 250. The image processor 250 may also be provided in the controller 2.

Although not illustrated in the drawings, in FIG. 5, a sensor configured to detect a position of the anode 101 in a direction of gravity may be used instead of the camera 240 and the image processor 250. As the anode 101 is consumed, the anode 101 moves in a direction opposite to the direction of gravity, for example, an upward direction in FIG. 5. For example, one or at least two sensor(s) may be arranged in the direction of gravity, the position of the anode 101 in the direction of gravity may be sensed, e.g., determined, based on which of the one or at least two sensor(s) detects the anode 101, and the weight of the anode 101 may be sensed, e.g., determined, based on the position of the anode 101. For example, a micro switch, an optical sensor, a magnetic sensor, and the like may be used as the sensor. When a single sensor is used, when the anode 101 is detected by the single sensor, it may be recognized that the consumption of the anode 101 has reached a certain reference value.

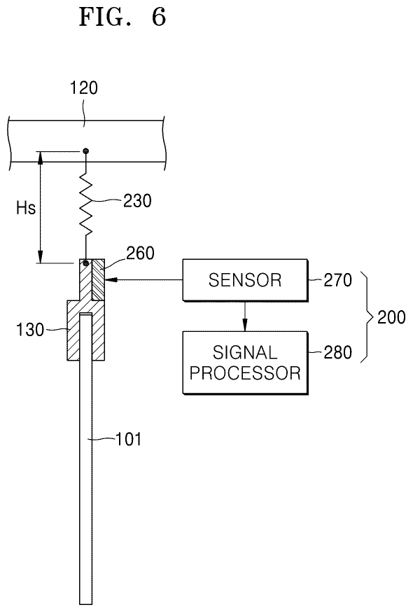

FIG. 6 is a configuration diagram schematically illustrating an embodiment of the weight sensor 200. Referring to FIG. 6, the anode 101 may be installed in a state of being suspended from the supporter 120 with the spring 230 therebetween. The anode 101 may be installed such that the weight of the anode 101 is applied to the spring 230. A reflective pattern 260 may be provided above the anode 101. The reflective pattern 260 indicates, e.g., includes or has, a pattern of which a reflectance changes in the direction of gravity, e.g., a pattern that has varying reflectance in the direction of gravity. For example, the reflective pattern 260 may include a gray pattern having a gradient in the direction of gravity. For example, the reflective pattern 260 may have a form in which a plurality of reflectors respectively having different reflectances are intermittently arranged in the direction of gravity. The weight sensor 200 may be configured to sense an amount of light reflected from the reflective pattern 260. For example, the reflective pattern 260 may be arranged on the electrode holder 130. A sensor 270 may include an optical sensor. The sensor 270 may be configured to irradiate light to the reflective pattern 260 and detect the light reflected from the reflective pattern 260. A detection signal of the sensor 270 is input to a signal processor 280, the signal processor 280 may be configured to output a signal corresponding to an amount of the reflected light, and the weight of the anode 101 may be sensed, e.g., determined. The signal processor 280 may also be provided in the controller 2.

Referring to FIG. 1, the controller 2 may be configured to generate a maintenance signal for the anode 101 based on a result of sensing by the weight sensor 200. For example, the maintenance signal may be a cell degradation signal to notify degradation in performance of the unit battery cell 100 (or the battery cell stack 10) in which the anode 101 is arranged. For example, the maintenance signal may be an operation imbalance signal to notify imbalance of operation states between the unit battery cells 100 (or between the battery cell stacks 10). For example, the maintenance signal may be an anode replacement signal to notify that the anode 101 has to or should be replaced. For example, the maintenance signal may be a unit battery cell (or a battery cell stack) replacement signal to notify that the unit battery cell (or the battery cell stack) has to or should be replaced. For example, the maintenance signal may be a signal to notify the necessity of control on operation conditions (e.g., an amount of anolyte supply, an amount of air supply to the cathode) of the metal-air battery (or the metal-air battery system). The controller 2 may be configured to output the maintenance signal in forms of a visual signal, auditory signal, or a combination thereof through an output interface 5.

The output interface 5 may include, for example, various output devices capable of visual or auditory output. For example, the output interface 5 may include an auditory output device, a display device, or a combination thereof. The auditory output device may include, for example, a speaker, a beeper, and the like. As a device capable of providing visual information, the display device may include, for example, a display, a light-emitting display device (e.g., a light emitting diode (LED)), and the like.

The controller 2 may be configured to transmit the maintenance signal to external devices through wired or wireless communication. For example, the controller 2 may be configured to transmit the maintenance signal to a user terminal. For example, the controller 2 may be configured to transmit the maintenance signal to a central controller (e.g., a central controller of a power plant) configured to generally control the metal-air battery system. To do so, the controller 2 may include a communication module configured to support establishment of a wired communication channel, a wireless communication channel, or a combination thereof with external devices and communication through the established communication channels. The communication module may include one or a plurality of communication processor(s) configured to support wired communication, wireless communication, or a combination thereof. The communication module may include a wireless communication module (a cellular communication module, a near-field wireless communication module, Global Navigation Satellite system (GNSS) communication module, and the like), a wired communication module (a Local Area Network (LAN) communication module, a power-line communication module, and the like), or a combination thereof. The various types of communication modules may be integrated as a single component (a single chip and the like) or implemented as a plurality of components (a plurality of chips) separate from each other.

By using the disclosed configuration, the weight of at least one anode 101 of the plurality of unit battery cells 100 may be sensed. According to the disclosure, as the weight of the anode 101 itself is sensed, the weight of the anode 101 may be precisely sensed. When the sensed weight is less than or equal to a certain reference value, that is, when the consumption of the anode 101 is greater than or equal to a certain reference value, degradation in the performance due to, for example, a difference between anode consumptions of the unit battery cells may be reduced by replacing the consumed anode 101 with another, e.g., new, anode 101, replacing the unit battery cell 100 or the battery cell stack 10, or adjusting an amount of anolyte supply, an air supply, and the like provided to the unit battery cell 100 or the battery cell stack 10, and a metal-air battery 1 having stable performance and a metal-air battery system using the metal-air battery 1 may be implemented, e.g., provided.

The weight sensor 200 may be configured to sense, e.g., determine, the weight of the at least one anode 101 of the plurality of unit battery cells 100. In an embodiment, the weight sensor 200 may be configured to individually sense, e.g., determine, the weight of the anode 101 in each of the unit battery cells 100, and the weight sensor 200 according to an embodiment illustrated in FIGS. 3 to 6 may be applied to each of the unit battery cells 100.

In an embodiment, the weight sensor 200 may be configured to individually sense weights of some of the anodes 101 in the plurality of unit battery cells 100. When the weights 101 of the anodes 101 are to be sensed for all of the unit battery cells 100, a structure of the weight sensor 200 may be complicated, and cost of the metal-air battery 1 and the metal-air battery system using the same may increase. As described herein, the consumption of the anode 101 is dependent to, e.g., may depend on, a temperature, a flow state of the anolyte 102, the quality of the cathode 103, the amount of air supply to the cathode 103, and the like, and such factors may be influenced by the positions of the plurality of unit battery cells 100 in the alignment direction. In consideration of the positions of the plurality of unit battery cells 100, the weight of the anode 101 may be sensed for the unit battery cells at positions expected to have a greatest difference between the consumptions of the anodes 101. By doing so, simplification in the structures and reduction of costs of the metal-air battery 1 and the metal-air battery 1 using the metal-air battery 1 may be achieved.

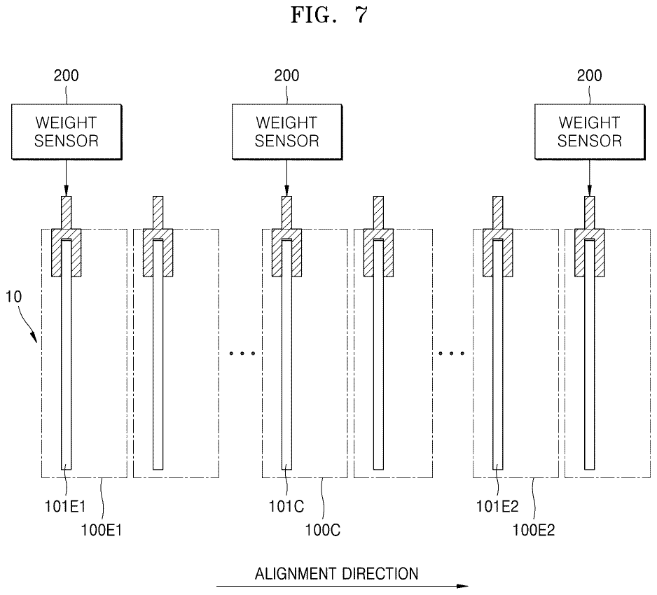

FIG. 7 illustrates an example of an arrangement of the weight sensor 200. Referring to FIG. 7, the plurality of unit battery cells 100 are arranged in an alignment direction. The plurality of unit battery cells 100 may form the battery cell stack 10 illustrated in FIG. 1. The plurality of unit battery cells 100 may include at least one first unit battery cell 100C located at a center portion in the alignment direction and second unit battery cells 100E1 and 100E2 arranged at both end portions in the alignment direction. The number of the first unit battery cell 100C may be one or at least two. The number of each of the second unit battery cells 100E1 and 100E2 may be one or at least two. The second unit battery cell to sense, e.g., determine, the weight of the anode 101 thereof may include, for example, the second unit battery cell 100E1 or the second unit battery cell 100E2, and may also include both of the second unit battery cells 100E1 and 100E2.

In an embodiment, for example, weights of anodes 101 of the first unit battery cell 100C and the second unit battery cell 100E1 are detected. To do so, two weight sensors 200 configured to sense, e.g., determine, the weight of the anode 101C of the first unit battery cell 100C and a weight of an anode 101E1 of the second unit battery cell 100E1 are applied. Each of the two weight sensors 200 may have the structures illustrated in FIGS. 3 to 6.

When a difference between the weight of the anode 101C of the first unit battery cell 100C and the weight of the anode 101E1 of the second unit battery cell 100E1 is greater than or equal to a reference value, a maintenance signal may be generated for the unit battery cell having a less weight of the anode. For example, the difference between the weight of the anode 101C of the first unit battery cell 100C and the weight of the anode 101E1 of the second unit battery cell 100E1 is greater than or equal to a reference value (e.g., 20%), a maintenance signal may be generated for the unit battery cell having a less weight of the anode between the anode 101C of the first unit battery cell 100C and the anode 101E1 of the second unit battery cell 100E1.

When the weight of the anode 101C of the first unit battery cell 100C and a weight of an anode 101E2 of the second unit battery cell 100E2 are sensed, when a difference between the weight of the anode 101C of the first unit battery cell 100C and the weight of the anode 101E2 of the second unit battery cell 100E2 is greater than or equal to a reference value (e.g., 20%), a maintenance signal for a unit battery cell having a less weight of the anode between the anode 101C of the first unit battery cell 100C and the anode 101E2 of the second unit battery cell 100E2 may be generated.

When the weight of the anode 101C of the first unit battery cell 100C, the weight of the anode 101E1 of the second unit battery cell 100E1, and the weight of the anode 101E2 of the second unit battery cell 100E2 are sensed, when a difference between a lowest weight and a highest weight among the anode 101C, the anode 101E1, and the anode 101E2 is greater than or equal to a reference value (e.g., 20%), a maintenance signal may be generated for the unit battery cell having the lowest weight of the anode. When the weight of the anode having the highest weight among the anode 101C, the anode 101E1, and the anode 101E2 and the weight of the other two anodes are compared and the difference is a greater than or equal to reference value (e.g., 20%), a maintenance signal may be generated for two unit battery cells respectively including the other two anodes.

When each of the first unit battery cell and the second unit battery cell is provided in a plurality, whether to generate a maintenance signal may be determined based on a difference between an average of measured weights of anodes of a plurality of first unit battery cells and an average of measured weights of anodes of a plurality of second unit battery cells. A maintenance signal may also be generated based on a maximum value of the difference between the measured weights of the anodes. For example, whether to generate a maintenance may also be determined based on a difference between a weight of the anode having a highest (or a lowest) weight among the anodes of the plurality of first unit battery cells and a weight of the anode having a lowest (or a highest) weight among the anodes of the plurality of second unit battery cells.

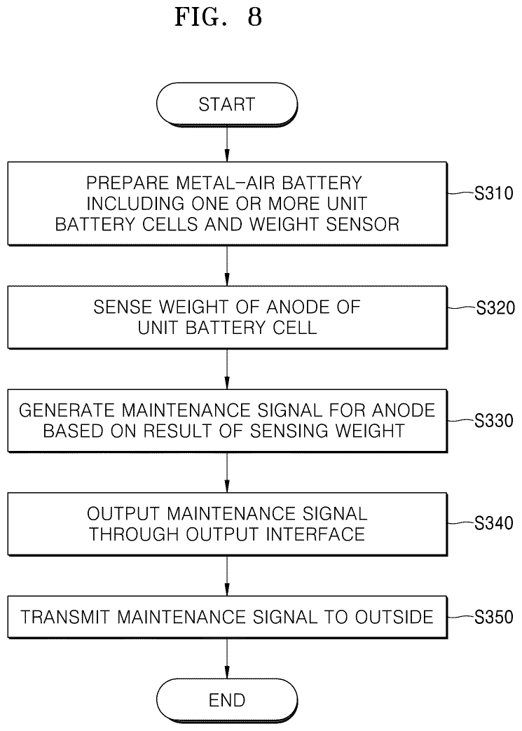

FIG. 8 is a flowchart of an embodiment of an operation method of a metal-air battery system. An embodiment of an operation method of the metal-air battery system will be described with reference to FIGS. 1 to 8. Referring to FIG. 8, the operation method of the metal-air battery system may include preparing the metal-air battery 1 (S310), sensing, e.g., determining, a weight of the anode 101 of one or more unit battery cell(s) 100 by using the weight sensor 200 (S320), and generating a maintenance signal for the anode 101 based on a result of sensing by the weight sensor 200 (S330).

The metal-air battery 1, as described with reference to FIGS. 1 to 6, includes the anolyte 102, the anode 101, and the cathode 103. The metal-air battery 1 may include one or more unit battery cell(s) configured to generate electricity by using an ORR in the cathode 103 and an oxidation reaction in the anode 101 and the weight sensor 200 configured to sense, e.g., determine, the weight of the anode of the one or more unit battery cell(s) 100. The weight sensor 200 may have any one of the structures illustrated in FIGS. 3 to 6. Generating the maintenance signal may be performed, for example, by the controller 2. The maintenance signal 2 may include, for example, a replacement signal for the anode 101 that has been consumed, and may also include a signal to notify degradation in the performance of the unit battery cell 100 including the anode 101 that has been consumed.

The operation method of the metal-air battery system according to an embodiment may include outputting the maintenance signal through the output interface 5 (see FIG. 1) (S340), transmitting the maintenance signal to the outside (S350) of the metal-air battery system, or a combination thereof. For example, as a visual signal, auditory signal, or a combination thereof, the maintenance signal may be output through the output interface 5. The transmission to the outside of the metal-air battery system may include, for example, transmission to the user terminal, the central controller, or a combination thereof.

The weight sensor 200 may be configured to sense, e.g., determine, the weight of the anode 101 in at least one unit battery cell among the unit battery cells 100. In an embodiment, the weight sensor 200 may be configured to sense, e.g., determine, the weights of the anodes 101 in all of the unit battery cells 100. In an embodiment, the weight sensor 200 may be configured to sense, e.g., determine, the weights of the anodes 101 in some of the unit battery cells 101. For example, the sensing of the weight (S320) may include sensing, e.g., determining, the weight of the anode 101C and the weight of the anode 101E1, or the anode 101E2 of at least one of the first unit battery cells 100C positioned at the center of the plurality of unit battery cells 100 and at least one of the second unit battery cells 100E1 and 100E2 positioned at both ends of the plurality of plurality of unit battery cells 100. Generating the maintenance signal (S330) may include generating the maintenance signal for the unit battery cell having a lower weight of the anode based on a difference between the weight of the anode 101C1 of the first unit battery cell 100C that has been measured and the weights of the anodes 101E1, 101E2, or a combination thereof of the second unit battery cells 100E1, 100E2, or a combination thereof that have been measured, a difference between an average of the weights of the anodes 101C1 of the first unit battery cells 100C that have been measured and an average of the weights of the anodes 101E1, 101E2, or a combination thereof of the second unit battery cells 100E1, 100E2, or a combination thereof that have been measured, or a maximum value among the differences between the weight of the anode 101C1 of the first unit battery cell 100C that has been measured and the weights of the anodes 101E1, 101E2, or a combination thereof of the second unit battery cells 100E1, 100E2, or a combination thereof that have been measured.

The metal-air battery 1 may include the plurality of battery cell stacks 10. Each of the plurality of battery cell stacks 10 may include the plurality of unit battery cells 100, and the sensing of the weight (S320) may include sensing, e.g., determining, a weight of at least one anode 101 of each of the plurality of battery cell stacks 10. For example, for each of the plurality of battery cell stacks 10, the weights of all the anodes 101 may be sensed, and the weights of some of the anodes 101 may be sensed, and as described herein, the weights of the anode 101C, 101E1, and 101E2 of some of the unit battery cells (i.e., the first unit battery cell 100C, the second unit battery cell 100E1, and the second unit battery cell 100E2) may be sensed according to positions of the plurality of unit battery cells 100 in the alignment direction.

In an embodiment, based on a result of the sensing of the weights, an anode having lower weight, or a battery cell, or a battery cell stack having a lower weight of the anode may be replaced. In an embodiment, an amount of anolyte supply, an amount of air supply to the cathode, or a combination thereof may be adjusted based on the result of sensing of the weight. The adjustment on the amount of anolyte supply and the amount of air supply to the cathode may be performed for a battery cell (or a battery cell stack) including the anode having the lower weight or a battery cell (or a battery cell stack) including the anode having the higher weight, based on the result of sensing.

Although numerous details have been particularly described above, the details are to be understood as examples of specific embodiments rather than as limitation on the scope of the disclosure. For example, it will be understood to those skilled in the art that the structure of the metal-air battery according to an embodiment may be variously modified. Therefore, the scope of the disclosure should be defined based on the technical spirit written in the following claims, not based on the embodiments described above.

According to an embodiment, consumption of an anode may be sensed by determining the weight of the anode itself.

According to an embodiment, by sensing weights of anodes themselves in one or more unit battery cells, degradation in the performance of a metal-air battery due to, for example, a difference between the anode consumptions of the unit battery cells may be sensed.

According to an embodiment, a metal-air battery having stable performance of power generation may be implemented, e.g., provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A metal-air battery comprising:
a unit battery cell comprising an anolyte, a supporter, an anode being suspended from the supporter, and a cathode, the unit battery cell being configured to generate electricity by using an oxygen reduction reaction in the cathode and an oxidation reaction of the anode; and
a weight sensor configured to determine a weight of the anode of the unit battery cell.

2. The metal-air battery of claim 1, wherein
the weight sensor comprises a load cell, and
the load cell is between the anode and the supporter.

3. The metal-air battery of claim 1, wherein
the metal-air battery further comprises a spring,
the spring is between the anode and the supporter, and
the weight sensor is configured to measure a length of the spring from an image of the spring.

4. The metal-air battery of claim 1, wherein
the metal-air battery further comprises a spring,
the anode comprises a reflective pattern with varying reflectance in a direction of gravity,
the spring is between the anode and the supporter, and
the weight sensor is configured to measure an amount of light reflected from the reflective pattern.

5. The metal-air battery of claim 1,
comprising a plurality of the unit battery cells, wherein
the plurality of unit battery cells comprises: at least one first unit battery cell positioned at a center portion in an alignment direction; and second unit battery cells positioned at both end portions in the alignment direction, and
the weight sensor is configured to determine a weight of an anode of at least one first unit battery cell of the at least one first unit battery cell and a weight of an anode of at least one second unit battery cell of the second unit battery cells.

6. The metal-air battery of claim 1,
comprising a plurality of battery cell stacks each comprising a plurality of the unit battery cell, and
the weight sensor is configured to determine a weight of at least one anode of each of the plurality of battery cell stacks.

7. The metal-air battery of claim 1, wherein the anode comprises zinc, iron, aluminum, or an alloy comprising at least two of zinc, iron, and aluminum.

8. A metal-air battery system comprising:
a metal-air battery comprising a unit battery cell and a weight sensor, wherein the unit battery cell comprises an anolyte, a supporter, an anode being suspended from the supporter, and a cathode and is configured to generate electricity by using an oxygen reduction reaction in the cathode and an oxidation reaction of the anode, and the weight sensor is configured to determine a weight of the anode of the unit battery cell; and
a controller configured to, based on a result of sensing by the weight sensor, generate a maintenance signal for the anode.

9. The metal-air battery system of claim 8, wherein
the controller is configured to output the maintenance signal through an output interface, transmitting the maintenance signal to outside of the metal-air battery system, or a combination thereof.

10. The metal-air battery system of claim 8, wherein
the metal-air battery comprises a plurality of the unit battery cells,
the plurality of unit battery cells comprise: at least one first unit battery cell positioned at a center portion in an alignment direction; and second unit battery cells positioned at both end portions in the alignment direction,
the weight sensor is configured to sense weights of anodes of at least one first unit battery cell of the at least one first unit battery cell and at least one second unit battery cell of the second unit battery cells, and the controller is configured to, when a difference between the weight of the anode of the at least one first unit battery cell that has been measured and the weight of the anode of the at least one second unit battery cell of the second unit battery cells that has been measured is greater than or equal to a reference value, generate a maintenance signal for a unit battery cell having a lower weight of the anode.

11. The metal-air battery system of claim 10, wherein
the controller is configured to generate the maintenance signal based on differences between an average value of the weights of the anodes of the first unit battery cells that have been measured and an average value of the weights of the anodes of the second unit battery cells that have been measured.

12. The metal-air battery system of claim 10, wherein
the controller is configured to generate the maintenance signal based on a maximum value of differences between the weights of the anodes of the first unit battery cells that have been measured and the weights of the anodes of the second unit battery cells that have been measured.

13. The metal-air battery system of claim 8,
comprising a plurality of battery cell stacks each comprising a plurality of the unit battery cell, and
the weight sensor is configured to determine a weight of at least one anode of each of the plurality of battery cell stacks.

14. The metal-air battery system of claim 8, wherein the anode comprises zinc, iron, aluminum, or an alloy comprising at least two of zinc, iron, and aluminum.

15. An operation method of a metal-air battery system, the operation method comprising:
preparing a metal-air battery and a weight sensor, wherein the metal-air battery comprises a unit battery cell comprising an anolyte, a supporter, an anode being suspended from the supporter, and a cathode, the unit battery cell is configured to generate electricity by using an oxygen reduction reaction in the cathode and an oxidation reaction of the anode, and the weight sensor is configured to determine a weight of the anode of the unit battery cell;
determining a weight of the anode of the unit battery cell using the weight sensor; and
generating a maintenance signal for the anode, based on a result of sensing by the weight sensor.

16. The operation method of claim 15, further comprising
displaying the maintenance signal through an interface, transmitting the maintenance signal to outside of the metal-air battery system, or a combination thereof.

17. The operation method of claim 15, further comprising,
in the generating of the maintenance signal, the maintenance signal is generated when the weight of the anode that has been measured is less than or equal to a reference value.

18. The operation method of claim 15, wherein
the metal-air battery comprises a plurality of the unit battery cell,
the plurality of unit battery cells comprise at least one first unit battery cell positioned at a center portion in an alignment direction and second unit battery cells positioned at both end portions in the alignment direction, and
the sensing of the weight comprises sensing weights of anodes of at least one first unit battery cell of the at least one first unit battery cell and at least one second unit battery cell of the second unit battery cells, and
the generating of the maintenance signal comprises generating a maintenance signal for a unit battery cell having a lowest weight of the anode, based on one of: a difference between weights of anodes of the first unit battery cells that have been measured and weights of anodes of the second unit battery cells that have been measured; a difference between an average value of the weights of the anodes of the first unit battery cells that have been measured and an average value of the weights of the anodes of the second unit battery cells that have been measured; and a maximum value among the differences between the weights of the anodes of the first unit battery cells that have been measured and the weights of the anodes of the second unit battery cells.

19. The operation method of claim 15, further comprising
adjusting an amount of supply of the anolyte, an amount of air supply to the cathode, or a combination thereof, based on a result of sensing by the weight sensor.

20. The operation method of claim 15, wherein
the metal-air battery comprises a plurality of battery cell stacks each comprising a plurality of the unit battery cell, and
the sensing of the weight comprises determining a weight of at least one anode of each of the plurality of battery cell stacks.
